(19) United States
(12) Patent Application Publication
(10) Pub. No.: US 2007/0259185 A1
(43) Pub. Date: Nov. 8, 2007

(54) High-temperature-resistant composite and method of producing the composite

(75) Inventors: Karl Hingst, Augsburg (DE); Martin Christ, Augsburg (DE); Elmar Eber, Kuhlenthal (DE)

Correspondence Address: LERNER GREENBERG STEMER LLP, P O BOX 2480, HOLLYWOOD, FL, 33022-2480, US

(73) Assignee: SGL Carbon AG

(21) Appl. No.: 11/800,505

(22) Filed: May 4, 2007

(30) Foreign Application Priority Data
May 4, 2006 (EP) 06 009 214.5

(51) Int. Cl. B32B 9/00; C01B 31/00; C04B 37/00

(52) U.S. Cl. 428/408; 264/29.1; 156/89.25

(57) ABSTRACT

High-temperature-resistant composites are formed of at least two layers of high-temperature-resistant carbon-based materials or graphite-based materials. The layers are joined to one another by a carbonized binder which contains planar anisotropic graphite particles. The planar anistropic graphite particles have a high anisotropy in respect of their crystal structure and their thermal conductivity are added to the carbonizable binder.

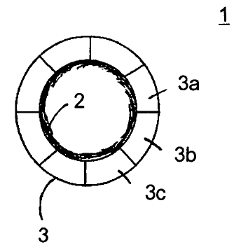

### CROSS-REFERENCE TO RELATED APPLICATION

This application claims the priority, under 35 U.S.C. § 119, of European application EP 06 009 214.5, filed May 4, 2006; the prior application is herewith incorporated by reference in its entirety.

### BACKGROUND OF THE INVENTION

### Field of the Invention

The invention relates to high-temperature-resistant composites which are suitable for use in thermal insulations, heat shields, furnace internals, etc.

Materials of construction for high-temperature furnaces and reactors have to be both thermally insulating and resistant to high temperatures and inert toward the substances which react or are liberated in an interior of the furnace or reactor. Owing to their great heat stability, materials of construction based on carbon or graphite are frequently used for high-temperature applications, i.e. at temperatures above 800° C. or even above 1000° C. in a non-oxidizing atmosphere.

The heat loss to be avoided by use of insulation can occur both by thermal radiation (predominantly at temperatures above 1000° C.) and by thermal conduction and convection (predominantly at temperatures below 1000° C.). Dense reflective materials are suitable for preventing thermal radiation and convection but on the other hand the thermal conductivity increases with increasing density. Materials having a relatively low density are suitable for suppressing thermal conduction but on the other hand are less suitable for preventing convection.

Thermal insulations are therefore preferably configured as layered composites which contain at least one high-temperature-resistant material having a relatively low thermal conductivity (e.g. a felt composed of carbon fibers) for insulation against thermal conduction and a second, dense reflective material (e.g. graphite foil) for insulation against thermal radiation and convection. The denser material also contributes to the mechanical stability of the composite.

Graphite foil is particularly useful as a constituent of composites for thermal insulations since it is pliable and flexible and can thus be fitted to the round shapes typical of furnaces and reactors. In addition, graphite foil has a highly anisotropic thermal conductivity. Owing to the preferential thermal conduction in the plane of the foil, temperature equilibration occurs and local overheating (hot spots) in the insulation are avoided. Further advantages are the low fluid permeability and the reflective surface of graphite foil. Graphite foil typically has a thickness in the range from 0.3 to 1.5 mm and a density in the range from 0.4 to 1.6 g/cm³.

Graphite foil is obtained in a known manner by compaction of graphite expanded by thermal shock treatment (graphite expandate).

International patent disclosure WO 2004/063612, corresponding to U.S. patent publication No. 2004/0220320 A1, describes a thermally insulating composite containing at least one layer of relatively highly compacted graphite expandate (density at least 0.4 g/cm³, preferably from 0.5 to 1.6 g/cm³) and at least one layer of less highly compacted graphite expandate (density less than 0.4 g/cm³, preferably from 0.05 to 0.3 g/cm³) which are joined to one another by a carbonized binder (carbonized phenolic resin, pitch or the like). The layer of more highly compacted graphite expandate is made as thin as the requirements for mechanical stability and impermeability permit (typically from 0.3 to 1.5 mm) and the layer of less highly compacted graphite expandate is made as thick as necessary for thermal insulation (typically from 5 to 20 mm). The structure can also be sandwich-like with two layers of more highly compacted graphite expandate enclosing a layer of less highly compacted graphite expandate. This stops particles from breaking away from the less highly compacted layer.

The production of the composite according to WO 2004/063612 contains the main steps of:
a) production of at least one less highly compacted layer of graphite expandate and at least one more highly compacted layer of graphite expandate;
b) joining of the layers to one another, in which:
c) b1) the less highly compacted layer is coated with a carbonizable binder;
d) b2) solvents present are evaporated from the binder;
e) b3) the more highly compacted layer is placed on the binder-coated less highly compacted layer; and
f) b4) the binder is carbonized by heat treatment in a nonoxidizing atmosphere at a temperature corresponding to at least the use temperature of the insulation material to be produced (typically from 800 to 1000° C.).

International patent disclosure WO 2004/092628, corresponding to U.S. patent publication No. 2004/0076810 A1, discloses a thermal insulation material which contains at least one layer or a laminate of a plurality of layers of graphite foil and at least one layer of a thermally insulating carbon fiber reinforced carbon material which is isotropic in respect of the thermal conductivity. The thickness of the laminate of graphite foils is preferably up to 2 cm and the thickness of the isotropic insulating layer is from 1 to 10 cm at a density of preferably from 0.1 to 0.5 g/cm³. The inner (i.e. facing the heat source) layer of graphite foil is reflective and prevents local overheating. Owing to its low density, the outer layer reduces the loss of heat by thermal conduction.

The graphite foils to be laminated to one another are stacked on top of one another with a layer of a material which decomposes thermally to leave a carbon residue (e.g. Kraft paper) and has been coated on both sides with a carbonizable binder (e.g. phenolic resin) between each two graphite foils. The pores formed in the decomposition of the intermediate layers allow the gases liberated during curing and carbonization of the binder to escape. The laminate of graphite foils is joined to the layer of isotropic carbon fiber reinforced carbon by a carbonizable cement. The cement preferably contains solvents and a polymerizable monomer together with carbon particles as filler in a proportion by volume of from 20 to 60%. Carbon black, pitch or milled coke, in each case having a particle size of less than 20 μm, were proposed as suitable carbon particles. In the formation of the bond between graphite foil laminate and the layer of carbon fiber reinforced carbon, the cement is first activated at a temperature of from 250° C. to 300° C. and subsequently carbonized by further heating to 800° C.

The bond between the layers formed of various materials is critical for the reliable functioning of such layer composites. The bond has to ensure reliable cohesion but on the other hand must not result in significant thermal conduction between the layers to be joined.

A further problem is the buildup of stresses as a result of the different thermal expansion of the various materials.

According to the prior art, the bond between the layers of materials is achieved by use of a carbonizable binder which may, if appropriate, contain carbon particles as a filler and is subsequently carbonized.

### SUMMARY OF THE INVENTION

It is accordingly an object of the invention to provide a high-temperature-resistant composite and a method of producing the composite which overcome the above-mentioned disadvantages of the prior art devices and methods of this general type,

With the foregoing and other objects in view there is provided, in accordance with the invention a high-temperature-resistant composite. The composite contains a carbonized binder having planar anisotropic graphite particles, and at least two layers joined to one another by the carbonized binder. Each of the layers is formed of a high-temperature-resistant carbon-based material or a high-temperature-resistant graphite-based material.

It has been found that the cohesion between the layers of various graphite-based materials or carbon-based materials can be improved when planar particles of graphite, e.g. natural graphite or compacted graphite expandate, which have a high anisotropy in respect of their crystal structure and their thermal conductivity are added to the carbonizable binder.

In accordance with an added feature of the invention, the at least two layers each is formed from a graphite foil, graphite expandate compacted to a density in a range from 0.02 to 0.3 g/cm³, a hard carbon fiber felt, a soft carbon fiber felt, or a carbon fiber reinforced carbon.

In accordance with an additional feature of the invention, the at least two layers include at least one curved layer containing graphite expandate compacted to a density in a range from 0.02 to 0.3 g/cm³, and the at least one curved layer is formed of individual segments joined to one another by the carbonized binder containing the planar anisotropic graphite particles.

In accordance with a further feature of the invention, the planar anisotropic graphite particles are flakes of natural graphite or particles obtained by comminuting graphite expandate compacted to form planar structures. Ideally, the planar anisotropic graphite particles have a mean diameter in a range from 1 to 250 μm. Furthermore, a thermal conductivity in the planar anisotropic graphite particles along layer planes of the planar anisotropic graphite particles is at least a factor of 10 higher than that perpendicular to the layer planes of the planar anisotropic graphite particles.

With the foregoing and other objects in view there is further provided, in accordance with the invention a composite component containing an apparatus being either a heat shield, thermal insulation, furnace internals, or other high-temperature resistant parts. The apparatus is formed of a high-temperature-resistant composite containing a carbonized binder having planar anisotropic graphite particles and at least two layers joined to one another by the carbonized binder. Each of the two layers is formed of a high-temperature-resistant carbon-based material or a high-temperature-resistant graphite-based material.

With the foregoing and other objects in view there is provided, in accordance with the invention a process for joining two items being either layers or components and formed from a high-temperature-resistant carbon-based material or a high-temperature-resistant graphite-based material. The method includes the steps of applying a carbonizable binder having planar anisotropic graphite particles to a surface of a first item to be joined to a second item resulting in a binder-coated surface and applying the second item onto the binder-coated surface of the first item. The carbonizable binder is then cured. Then one of carbonization and graphitization of the carbonizable binder is performed.

In accordance with an added mode of the invention, there is the step of producing at least one of the first and second layers by winding of textile structures containing carbon fibers or long sheets of graphite foil.

In accordance with another mode of the invention, there is the step of forming at least one of the first and second layers as a curved layer containing the graphite expandate compacted to a density in the range from 0.02 to 0.3 g/cm³. This is achieved by producing individual segments which when assembled form the curved layer, joining the individual segments by use of the carbonizable binder containing the planar anisotropic graphite particles, curing the carbanizable binder, and performing one of carbonization and graphitization of the carbonizable binder.

Preferably the items to be joined to one another are tubes or plates containing one of carbon-based materials and graphite-based materials.

In accordance with a further mode of the invention, there is the step of setting a mass of the planar anisotropic graphite particles added to the carbonizable binder to be at least 5% of a mass of the carbonizable binder.

Other features which are considered as characteristic for the invention are set forth in the appended claims.

Although the invention is illustrated and described herein as embodied in a high-temperature-resistant composite and a method of producing the composite, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, cross-sectional view of a cylindrical component containing an inner wound layer and an outer layer made up of individual segments of pressed graphite expandate according to the invention.

### DETAILED DESCRIPTION OF THE INVENTION

In contrast to conventional fillers such as milled coke, the particles added to the carbonizable binder according to the present invention are planar, i.e. their dimension in the flat area (diameter) is significantly greater than their thickness.

One filler which is suitable for the purposes of the invention is, for example, natural graphite whose particles are flake-like. An alternative is particles which are obtained by comminuting (breaking up such as cutting, milling, chopping or shredding) of graphite expandate which has been compacted to form planar structures (e.g. graphite foil). Offcuts which are inevitably obtained in the production of seals or other articles from graphite foil are advantageously utilized for this purpose. The particles obtained in this way are platelet-like.

The mean diameter of the particles added according to the invention to the carbonizable binder is from 1 to 250 μm; preference is given to particles having a mean diameter of from 5 to 55 μm.

In both variants of the particles added according to the invention to the carbonizable binder, i.e. both in the case of natural graphite flakes and in the case of the platelet-like particles obtained by comminuting of graphite foil, the typical layer plane structure of the graphite, which is responsible for the high anisotropy of the thermal conductivity which is typical of graphite, is present. The thermal conductivity along the layer planes, i.e. in the plane of the particles, is at least a factor of 10, preferably at least a factor of 20, higher than perpendicular to the layer planes. In the case of graphite foil, for example, the thermal conductivity perpendicular to the plane of the foil is only about 3-5 W/K*m, while the conductivity parallel to the plane of the foil reaches values in the range from about 100 W/K*m (at a density of 0.6 g/cm³) to about 260 W/K*m (at a density of 1.5 g/cm³).

Since the planar anisotropic particles in the binder layer are aligned parallel to the adjoining layers of material, the thermal conduction across the interface between the various materials is only low. In the case of milled coke as a filler, the thermal conduction between the layers of material is suppressed to a lesser extent because of the more isotropic thermal conductivity of the coke.

A further advantageous effect of the planar graphite particles in the binder layer is that a binder layer containing such particles functions as stress equalization layer, i.e. mechanical stresses between the various materials joined to one another via the binder layer are reduced. It is assumed that this effect is attributable to the known lubricating action of graphite, but the invention is not tied to this explanation.

The mass of the particles is at least 5% of the mass of the binder used. Particle masses of from 10 to 30% of the binder mass have been found to be particularly useful, but the invention is not restricted to this range of values for the mass ratio of particles to binder.

As carbonizable binders, it is possible to use the binders known from the prior art, e.g. phenolic resins, furan resins, epoxy resins, pitch or the like. The curing, carbonization and, if appropriate, graphitization of the binder in the layer composites is carried out in a way known to those skilled in the art. Curing can, for example, be effected using the known vacuum bag process. The carbonization or graphitization occurs in a known manner at temperatures in the range from 800 to 2000° C.

The carbonizable binders containing planar anisotropic graphite particles are suitable for producing layer composites composed of various carbon or graphite materials which can be used for high-temperature applications or precursors thereof, for example layers of compacted graphite expandate of widely varying density (including graphite foil), hard carbon fiber felts, soft carbon fiber felts, carbon fiber reinforced carbon, and fabric prepregs. The composites of the invention contain at least two layers of high-temperature-resistant carbon-based or graphite-based materials.

Depending on the application, a person of average skill in the art will choose suitable materials according to their known specific advantages and join them according to the invention by use of a carbonizable binder containing planar anisotropic graphite particles (graphite flakes or platelets) to form a layer composite having the desired sequence of layers and subsequently carbonize the binder.

For the purposes of the present invention, carbon fibers are all types of carbon fibers regardless of the starting material, with polyacrylonitrile, pitch and cellulose fibers being the most widely used starting materials. In the carbon fiber reinforced carbon materials, the carbon fibers can be present as, for example, individual fibers, short fibers, fiber bundles, fiber mats, felts, woven fabrics or non-crimped fabrics, also combinations of a plurality of the fiber structures mentioned. The woven fabrics can include long fibers or carbon fibers which have been broken by drawing and respun (known as staple fibers).

Materials made up of carbon fibers or reinforced with carbon fibers contribute to the stiffness and strength of the composite. Layers having a low density, e.g. layers composed of carbon fiber felt or graphite expandate which in contrast to graphite foil is compacted only to a density of from 0.02 to 0.3 g/cm³, have a particularly good thermally insulating effect because of their low thermal conductivity. A further advantage is their low weight.

The particular advantages of graphite foil for use in thermal insulations and the like have already been presented.

Suitable materials for the layer which directly adjoins the interior of the furnace, reactor or the like are graphite foil and also materials containing staple fibers. Owing to the drawing/breaking treatment, these fibers produce hardly any dust which could contaminate the interior of the furnace or reactor. The problem of dust formation by fine fibrils from conventional carbon fiber reinforced thermal insulations, which lead to contamination of the interior of the furnace or reactor to be insulated, is referred to in, for example, international patent disclosure WO 2004/063612.

The production of, in particular, curved carbon fiber reinforced layers by the winding technique is known, see European Patent EP 1 157 809 (corresponding to U.S. Pat. No. 6,641,693). Here, elongated (threads, yarns, rovings, ribbons or the like) or/and planar textile structures (woven fabrics, lay-ups, felts) composed of carbon fibers which may, if appropriate, be impregnated with a carbonizable binder are wound up on a shaping mandrel.

Curved layers containing graphite foil can be produced by winding up a long sheet of graphite foil.

Between the various layers of material, a layer of the carbonizable binder containing planar anisotropic graphite particles is applied in each case. Thanks to the high viscosity of the binder containing planar anisotropic graphite particles, which is in the range from 20,000 to 30,000 mPa, this can be applied (e.g. applied by a spatula) without problems even to areas which are not horizontal, for example to curved surfaces as are typical of furnaces, reactors and pipes and are produced, for example, by the winding technique.

In the case of components which have to meet high demands in terms of mechanical stability, the layer composite preferably contains at least one layer which is cross-wound. Therefore, the wound layer contains strata which have been wound up at an opposed angle, e.g. +/−45°. Such layers can be obtained by winding up of elongated fiber structures such as threads, yarns, rovings or ribbons, with the fiber structures being able to be impregnated with a carbonizable binder. In the subsequent carbonization or graphitization, the binder which may be present in the wound fiber structures is carbonized or graphitized so as to produce a carbon fiber reinforced carbon material (CFRC).

It has been found to be advantageous for the surfaces to be joined to one another or at least the surface to which the binder is applied to be roughened.

It is also possible for individual components, e.g. tubes or plates, made of high-temperature-resistant carbon-based or graphite-based materials of construction to be joined to one another to form complex components by use of the carbonizable binder containing planar anisotropic graphite particles, e.g. natural graphite flakes or platelets of compacted graphite expandate.

A specific variant of the invention relates to curved components, for example cylindrical insulations for furnaces or reactors. The winding technique is preferably used for producing these. However, some of the materials coming into question, for example graphite expandate which has been compacted to a density in the range from 0.02 to 0.3 g/cm³, are not flexible enough to produce a layer of the corresponding material by winding a corresponding long sheet of material without the latter breaking. For this reason, it is proposed according to the invention that such curved layers be produced by assembling individual segments of the corresponding material. These segments are produced by customary shaping techniques, for example by pressing of graphite expandate in a mold corresponding to the shape of the segment to be produced or by cutting the segment from a block of pressed graphite expandate.

The cohesion between the segments within a layer is, like the cohesion between the individual layers, produced by use of a carbonizable binder to which planar anisotropic graphite particles have been added and which is subsequently cured and carbonized.

The FIGURE of the drawing schematically shows the cross section of a cylindrical component 1 containing an inner wound layer 2 which has been obtained, for example, by winding up a layer of graphite foil on a mandrel and an outer layer 3 which is made up of individual segments 3a, 3b, 3c . . . composed of pressed graphite expandate. A carbonizable binder to which planar anisotropic graphite particles had been added was applied both to the interface between layer 2 and layer 3 and also to the interfaces between the individual segments 3a, 3b, 3c.

Of course, further layers can be applied to the layer 3 composed of the segments 3a, 3b, 3c . . . , for example a stabilizing outer layer of wound-up carbon fibers.

### EXAMPLES

Some combinations of materials which are joined by a carbonizable binder containing planar anisotropic graphite particles to form layer composites which are suitable for use in thermal insulations, heat shields, etc. are proposed below.

A first example of a composite according to the invention contains a heat-reflecting inside (i.e. facing the interior of the furnace or reactor) layer of graphite foil, a layer of graphite expandate in which the graphite expandate is less highly compacted than in the graphite foil and which suppresses thermal conduction and a stabilizing outer layer of carbon fiber reinforced carbon (CFRC). The fiber reinforcement of the CFRC is formed either by a woven fabric or by layers of carbon fiber threads, yarns or rovings which are wound crosswise, e.g. at an angle of +/−45°.

A second example of a composite according to the invention contains a layer of pressed graphite expandate and a layer of CFRC.

A third example of a composite according to the invention contains a sandwich made up of two layers of graphite foil which enclose a layer of less highly compacted graphite expandate.

Table 1 lists the typical thicknesses and densities of the individual materials.

TABLE 1

| Material | Thickness/[mm] | Density/[g/cm³] |
|---|---|---|
| Graphite foil | 0.25–3 | 0.4–1.6 |
| Less highly compacted | 2–40 | 0.02–0.3 |
| graphite expandate | | |
| CFRC | 0.2–0.75 | 1.15 |

1. A high-temperature-resistant composite, comprising:
a carbonized binder containing planar anisotropic graphite particles; and
at least two layers, each formed of a material selected from the group consisting of high-temperature-resistant carbon-based materials and high-temperature-resistant graphite-based materials, joined to one another by said carbonized binder.

2. The composite according to claim 1, wherein said at least two layers each contain a material selected from the group consisting of a graphite foil, graphite expandate compacted to a density in a range from 0.02 to 0.3 g/cm³, a hard carbon fiber felt, a soft carbon fiber felt, and a carbon fiber reinforced carbon.

3. The composite according to claim 1, wherein said at least two layers include at least one curved layer containing graphite expandate compacted to a density in a range from 0.02 to 0.3 g/cm³, and said at least one curved layer formed of individual segments joined to one another by said carbonized binder containing said planar anisotropic graphite particles.

4. The composite according to claim 1, wherein said planar anisotropic graphite particles are one of flakes of natural graphite and particles obtained by comminuting graphite expandate compacted to form planar structures.

5. The composite according to claim 1, wherein said planar anisotropic graphite particles have a mean diameter in a range from 1 to 250 μm.

6. The composite according to claim 1, wherein a thermal conductivity in said planar anisotropic graphite particles along layer planes of said planar anisotropic graphite particles is at least a factor of 10 higher than that perpendicular to said layer planes of said planar anisotropic graphite particles.

7. A composite component, comprising:
an apparatus selected from the group consisting of heat shields, thermal insulations, furnace internals, and high-temperature resistant parts, said apparatus formed of a high-temperature-resistant composite containing a carbonized binder having planar anisotropic graphite particles and at least two layers joined to one another by said carbonized binder, each of said two layers formed of a material selected from the group consisting of high-temperature-resistant carbon-based materials and high-temperature-resistant graphite-based materials.

8. A process for joining two items selected from the group consisting of layers and components and formed from a material selected from the group consisting of high-temperature-resistant carbon-based materials and high-temperature-resistant graphite-based materials, which comprises the steps of:
applying a carbonizable binder having planar anisotropic graphite particles to a surface of a first item to be joined to a second item resulting in a binder-coated surface;
applying the second item onto the binder-coated surface of the first item;
curing the carbonizable binder; and
performing at least one of carbonization and graphitization of the carbonizable binder.

9. The process according to claim 8, which further comprises:
forming the first and second items as first and second layers to be joined to one another; and
forming the first and second layers from a material selected from the group consisting of graphite foil, graphite expandate compacted to a density in a range from 0.02 to 0.3 g/cm³, hard felt, soft felt, and carbon fiber reinforced carbon.

10. The process according to claim 9, which further comprises producing at least one of the first and second layers by winding of textile structures containing one of carbon fibers and long sheets of graphite foil.

11. The process according to claim 9, which further comprises forming at least one of the first and second layers as a curved layer containing the graphite expandate compacted to a density in the range from 0.02 to 0.3 g/cm³ by the steps of:
producing individual segments which when assembled form the curved layer;
joining the individual segments by use of the carbonizable binder containing the planar anisotropic graphite particles;
curing the carbanizable binder; and
performing one of carbonization and graphitization of the carbonizable binder.

12. The process according to claim 8, which further comprises forming the items to be joined to one another as components selected from the group consisting of tubes and plates containing one of carbon-based materials and graphite-based materials.

13. The process according to claim 8, which further comprises forming the planar anisotropic graphite particles from a material selected from the group consisting of flakes of natural graphite, and particles obtained by comminuting graphite expandate compacted to form planar structures.

14. The process according to claim 8, which further comprises forming the planar anisotropic graphite particles to have a mean diameter in a range from 1 to 250 μm.

15. The process according to claim 8, which further comprises setting a mass of the planar anisotropic graphite particles added to the carbonizable binder to be at least 5% of a mass of the carbonizable binder.

16. The process according to claim 8, which further comprising setting a thermal conductivity in the planar anisotropic graphite particles along layer planes of the planar anisotropic graphite particles to be at least a factor of 10 higher than that perpendicular to the layer planes of the planar anisotropic graphite particles.
